(19) United States
(12) Patent Application Publication
(10) Pub. No.: US 2026/0320971 A1
(43) Pub. Date: Oct. 15, 2026

(54) Computer Vision

(71) Applicant: Synoptix Limited, Bristol (GB)

(72) Inventors: George Daniel LEETE, Leicestershire (GB); Ivan Yurievich TYUKIN, Leicestershire (GB); Alexander GORBAN; Stephen MEASURES, Bristol (GB)

(21) Appl. No.: 19/117,275

(22) PCT Filed: Oct. 6, 2023
(86) PCT No.: PCT/GB2023/052601

§ 371 Date: Mar. 31, 2025

(30) Foreign Application Priority Data
Oct. 6, 2022 (GB) 2214703.7

(51) Int. Cl. G06V 10/764; G06N 20/00

(52) U.S. Cl. CPC G06V 10/764; G06N 20/00; G06V 2201/07

(57) ABSTRACT

Computer vision method comprising: obtaining (201) image data (103) associated with an image of a scene; operating (203), on the basis of the image data, a trained machine learning agent (109) to classify objects present in the image, wherein the operating comprises generating one or more input vectors characterising a plurality of principal components of the image; determining (209) an image classification status indicative of whether the trained machine learning agent has incorrectly classified at least one object in the image, wherein the determining comprises applying one or more stochastic rules to the one or more input vectors; and causing (217) further training of the machine learning agent on the basis of the determined image classification status.

### TECHNICAL FIELD

The present invention concerns computer vision. More particularly, but not exclusively, this invention concerns a computer vision method in which a trained machine learning agent is used to classify objects present in an image.

### BACKGROUND

Many applications require a computer to view and process an image to extract information about the content of the image. In order to facilitate extraction of that information by the computer, it is often necessary for the computer to perform some kind of classification of objects present in the image. In this context, classification of an object comprises identifying the object in the image (i.e. determining that it is present, without determining or categorising what the object is) and subsequently assigning the identified object to one of a number of object classes.

Machine learning is a commonly used technique for providing object classification functionality. Once a machine learning agent has been deployed, its performance can be altered and adjusted by further training (for example, by transfer learning). However, existing machine learning methods for object classification (and in particular the training of machine learning agents to perform such object classification) are highly computationally intensive and typically require substantial computing resources. Thus, the majority of such existing systems are hosted in datacentres or rely on remote computing resources. The substantial computing power required can preclude the use of such techniques in portable or deployed devices. Whilst the use of a remote computing resource can alleviate the need for provision of large amounts of computing power at the device, the resulting transfer of data between the device and the remote computing resource requires substantial bandwidth which is not always available (or reliable) in all locations to which the device may be deployed. Furthermore, even where there is sufficient bandwidth to support transmission of image data to a remote computing resource, to do so can risk breaches of regulatory requirements surrounding data protection (for example, where the image data is associated with an image including a person).

Existing systems that do perform post-deployment training typically rely on transfer learning. However, this type of learning often results in poor system accuracy due to a lack of task-specific data. It is also typically an inflexible solution, as to teach the new machine learning agent further information/add new data categories can require the repetition of the significant amounts (in some cases, all) of the training process, which means that the post-deployment training typically cannot practically be performed on a deployed device.

The present invention seeks to mitigate the above-mentioned problems. Alternatively or additionally, the invention seeks to provide an improved computer vision method.

### SUMMARY

According to a first aspect of the invention there is provided a computer vision method comprising:
obtaining image data associated with an image of a scene;
operating, on the basis of the image data, a trained machine learning agent to classify objects present in the image, wherein the operating comprises generating one or more input vectors characterising a plurality of principal components of the image;
determining an image classification status indicative of whether the trained machine learning agent has incorrectly classified at least one object in the image, wherein the determining comprises applying one or more stochastic rules to the one or more input vectors; and
causing further training of the machine learning agent on the basis of the determined image classification status.

By obtaining image data associated with an image of a scene and operating a trained machine learning agent on the basis of the image data to classify objects present in the image, the computer vision method can allow a device to identify objects present within an image and assign those objects to classes (i.e. to determine what the identified objects are). In doing so, the trained machine learning agent generates one or more input vectors which characterise a plurality of principal components of the image. Applying one or more stochastic rules to the one or more input vectors to determining an image classification status can enable the device to determine whether the trained machine learning agent has incorrectly classified any objects in the image. Thus, it is possible for the computer vision method to check whether it has performed the classification of objects in the image correctly. By causing further training of the machine learning agent on the basis of the determined image classification status, the computer vision method can enable the trained machine learning agent to reconfigure itself to provide improved performance. For example, the machine learning agent can reconfigure itself to overcome repeated errors due to features of the environment in which it is deployed. Thus, the computer vision method provides means for a deployed machine learning agent to adapt to the specific environment in which it is deployed (referred to as the machine learning agent's deployment environment). Furthermore, because the application of one or more stochastic rules requires relatively little computing power and does not require the transmission of large quantities of data to remote computing resources, the computer vision method enables deployed machine learning agents to adapt to their specific environments when deployed on edge devices (for example, having limited computing power and/or communication bandwidth). The use of one or more stochastic rules in order to detect incorrect classifications also enables the method to operate at a certifiable level of accuracy. The stochastic theorems use explicit probability calculations in deployment, allowing proper probability estimates of accuracy to be gained. Thus, despite the neural network's uncertainty in classification, it is possible to validate and/or certify the output of the network to a certain probability or accuracy.

It has also been found that by determining an image classification status using one or more stochastic rules, the present invention can detect adversarial attacks within the scene. The skilled person will understand that, in this context, an adversarial attack is where an object is disguised in such a way as to attempt to induce the machine learning agent to make an incorrect classification (for example, the use of dazzle camouflage on a car prototype). Even if the machine learning agent is subsequently unable to correctly identify an object making an adversarial attack, the device may be configured to flag the image as containing an adversarial attack (for example, for later review by a human operator).

It may be that the computer vision method is performed on a computer vision device. The computer vision device may comprise an automatic survey device. It may be that obtaining, operating, determining, and causing further training are performed at the computer vision device. It may be that obtaining the image data comprises operating a sensor to capture the image. The sensor may be part of the computer vision device. It may be that the sensor comprises a visible light camera. Thus, it may be that the image comprises a visible light image. It may be that the sensor comprises an infra-red light sensor. Thus, it may be that the image comprises an infra-red light image. It will be appreciated by the skilled person that other sensor and image types may additionally or alternatively be used. It may be that obtaining the image data comprises receiving the image data from an external source (for example, a remote sensor). It may be that the image data is received via a communication link (for example, a wired or wireless communication link). It may be that the image data is received via a communications network (for example, a local area network or the internet).

It may be that the trained machine learning agent comprises a neural network. However, it will be appreciated by the skilled person that other machine learning models may alternatively or additionally be used. It may be that the causing further training comprises performing further the further training. Thus, it may be that the further training is performed by the computer vision device. Performing the further training may comprise performing few shot learning. Alternatively or additionally, performing the further training may comprise performing transfer learning.

It may be that the method comprises, in response to the image classification status indicating that an incorrect classification has been made, generating supplementary training data (for example, for use in training the machine learning agent). Generating the supplementary training data may comprise correcting (for example, as described in further detail below) one or more classifications in respect of the image. Generating the supplementary training data may comprise attaching to the image meta-data indicating (for example, for each of the classified objects) an object class of the object and a location of the object (for example, in the form of a bounding box around the object). Where an incorrect classification comprises a failure to identify an object present in the image, generating the supplementary training data may comprise attaching to the image meta-data indicating an object class of the object and a location of the object (for example, in the form of a bounding box around the object). Where an incorrect classification comprises an assignment of an identified object to an incorrect object class, generating the supplementary training data may comprise changing the object class to which the object has been assigned. Where an incorrect classification comprises identification of an object which is not actually present in the image, generating the supplementary training data may comprise omitting (for example, deleting) the associated meta-data.

It may be that the generating of the one or more input vectors takes places in the process of the trained machine learning agent classifying objects present in the image. For example, it may be that the one or more input vectors are generated as an intermediate step in processing of the image data by the trained machine learning agent.

It may be that the classifying comprises identifying one or more (for example, all) objects present in the image. It will be understood by the skilled person that, in this context, identifying an object merely comprises determining that an object is present, without determining or categorising what the object is. It may be that the classifying comprises, for each of the identified one or more objects, assigning the object to one (for example, a most-likely one) of a plurality of predetermined object classes. In such cases, it may be that the classifying comprises assigning the object to a most likely one of a plurality of predetermined object classes. The plurality of predetermined object classes may be associated with categories of objects (for example, cars, buses, animals, etc. . . . ). The plurality of predetermined object classes may be specified by a user when configuring the device. Thus, the device may therefore be configured to monitor the presence of objects belonging to the one of more object classes. Thus, the classifying can be said to comprise generating one or more classifications (for example, associated with one or more objects present in the image).

It may be that incorrectly classifying an object comprises failing to identify an object present in the image. For example, it may be that the trained machine learning agent fails to distinguish an object from the surrounding background. In such a case, the machine learning agent would incorrectly determine that no object is present. It may be that incorrectly classifying an object comprises erroneously identifying an object in the image that is not present. For example, it may be that the trained machine learning agent incorrectly determines specific background features to constitute an object. In such a case, the machine learning agent would incorrectly determine that an object is present which is not actually there. It may be that incorrectly classifying an object comprises assigning an identified object to an incorrect object class. For example, it may be that the trained machine learning agent incorrectly allocates an identified object to a first object class, when it actually belongs to a second object class (for example, if the trained machine learning agent were to incorrectly allocate a bus to a “truck” object class in favour of a “bus” object class). It will be appreciated by the skilled person that, in this context, the acts of identifying an object and allocating the object to an object class can be together referred to as making a classification of the object.

It may be that the classifying comprises (for example, for each of the identified one or more objects) determining a classification confidence score indicative of the likelihood that the object belongs to a given object class. In such cases, it may be that the classifying comprises (for example, for each of the identified one or more objects), in response to the classification confidence score exceeding a classification threshold, assigning the object to the object class. It may be that the classifying comprises determining a plurality of classification confidence scores (for example, a classification confidence score for each identified object in respect of each of a plurality of object classes). Thus, the classifying may comprise determining a number of classification confidence scores equal to the product of the number of identified objects and the number of object classes. It may be that the classifying comprises determining a highest one of the plurality of classification confidence scores associated with an object and assigning the object to the object class associated with that classification confidence score. It may be that the classifying is performed on the basis of a plurality of classification thresholds. It may be that each object class is associated with a respective one of the plurality of classification thresholds. Thus, the value of the classification threshold may depend on the object class under consideration.

It may be that applying one or more stochastic rules comprises training the stochastic rules to identify incorrectly classified features. It may be that the one or more stochastic rules have been trained on the basis of the machine learning agent's representation of captured images (for example, of detected features in captured images). The training may be performed on the basis of two sets of input vectors (for example, a first set of input vectors for which the machine learning agent has correctly classified objects in the image and a second set of input vectors for which the machine learning agent has incorrectly classified one or more objects in the image). The training may comprise calculating the mean of the first set of input vectors. The training may comprise centring the first and second sets of input vectors around the calculated mean. The training may comprise performing principal component analysis on the first and second sets of input vectors. Thus, the training may comprise calculating (for example, in the form of a matrix) coefficients associated with each of a plurality of principal components of the captured image (for example, of object features in the captured image). The training may comprise performing a whitening transformation on the first and second sets of input vectors. The training may comprise clustering the false responses (i.e. the vectors for which the machine learning agent has incorrectly classified one or more objects). The training may comprise calculating one or more Fisher discriminants.

It may be that the one or more stochastic rules comprise one or more of rules 1-3 below:
1) Rule 1:
   Let X={x₁, . . . , xₘ} be given, xᵢ∈ [symbol] ₙ, and let x be drawn from a distribution satisfying assumption 1 (see below). Then x is Fisher separable from the set X with probability:

$$P \geq 1 - MC {( \frac{r}{2} )}^{n} , r ∈ ( 0 , 2 )$$

2) Rule 2:
   Consider sets X={x₁, . . . , xₘ} and Y={y₁, . . . , y_{K}}. Let p_{α}(α) be the probability density function associated with the random vector a, and a satisfies the condition that

$$f ( {y}_{i} ) > {\sum }_{i = 1}^{M} {α}_{m} {α}_{k} ( {z}_{m} , {z}_{k} )$$

for all yⱼ∈Y, with probability 1. Then the set X is separable from the set Y with probability:

$$P \geq 1 - {\sum }_{i = 1}^{M} {\int }_{H ( α , {x}_{i} ) \leq 0} {p}_{α} ( α ) d α ,$$

$$where :$$

$$H ( α , {x}_{i} ) = {\sum }_{k , m = 1}^{d} {α}_{k} {α}_{m} ( {z}_{k} , {z}_{m} ) - {\sum }_{m = 1}^{d} {α}_{m} ( {z}_{m} , {x}_{i} ) .$$

3) Rule 3:
   Let y be a given element of [symbol] ₙ, and let X={x₁, . . . , xₘ} be a finite sample of elements xᵢ drawn identically and independently from a distribution satisfying assumption 2 (see below). Then:
   a) y is Fisher separable from the set X with probability:

$$P \geq 1 - \frac{1}{2} MC {( {( 1 - {‖ y ‖}^{2} )}^{\frac{1}{2}} r )}^{n} ,$$

b) every x∈X is Fisher separable from y with probability:

$$P \geq 1 - MC {( ‖ y ‖ r )}^{n} .$$

i) Assumption 1:
   The probability density function, p, associated with the probability distribution of the random variable x exists, is defined on the unit ball [symbol] ₙ, and there exist C>0 and r∈(0,2) such that:

$${\int }_{{𝔹}_{n} ( \frac{1}{2} , z )} p ( x ) dx \leq {C ( \frac{r}{2} )}^{2} for all z ∈ {𝔹}_{n} , ‖ z ‖ = \frac{1}{2}$$

ii) Assumption 2:
   The probability density function, p, associated with the probability distribution of the random variable x exists, is defined on the unit ball [symbol] ₙ, and there exist C>0 and r∈ [symbol] _{≥0} such that:

$$p ( x ) < \frac{{Cr}^{n}}{{V}_{n} ( {𝔹}_{n} )} ,$$

for all x∈ [symbol] ₙ.

It may be that the machine learning agent is configured to learn (through its training) features of objects in the training dataset. It may be that these features are represented in the latent feature space as vectors (for example, highly reduced/compressed representations of the features in latent space). It may be that the deployed machine learning agent produces latent representations of the live scene (as determined by the training of the machine learning agent). It may be that the machine learning agent is configured to use the latent representations of the live scene to classify input vectors. It will be appreciated by the skilled person that this is based on the assumption that the data distribution of the deployment environment is equivalent to that of the training environment, and that this is not always true in practice. As a result, even the best trained models can be susceptible to spurious errors. It may be that the one or more stochastic rules also operate on the latent space. However, it may be that, rather than looking for similarity, the one or more stochastic rules are configured to calculate the cosine of the inner products of the input data and the training data to classify the data. It may be that the one or more stochastic rules are configured to determine whether an object within an image has been correctly classified on the basis of the calculated cosines (for example, by checking whether the calculated cosines of a feature vector is within an predetermined acceptable cosine range).

It may be that the plurality of principal components characterise a feature space associated with the image (for example, associated with detected objected features in the image). It may be that applying the one or more stochastic rules comprises separating the feature space into two or more portions. It may be that a first portion in the two or more portions is associated with classifications which are likely to be correct. It may be that a second portion in the two or more portions is associated with classifications which are likely to be incorrect. It may be that applying the one or more stochastic rules is dependent on one or more error checking thresholds. It may be that the one or more error checking threshold comprises a predetermined acceptable cosine range. The one or more stochastic rules may operate on the basis of the error checking thresholds to determine the ratio of false positives to false negatives determined by the one or more stochastic rules. It may be that the method comprises varying the at least one (for example, all) of the one or more error checking thresholds. For example, the method may comprise varying at least one (for example, all) of the one or more error checking thresholds to achieve a desired ratio of false positive results to false negative results returned by the one or more stochastic rules. It may be that the method comprises receiving user input of a desired ratio of false positive results to false negative results. Thus, a user can set a desired performance of the one or more stochastic rules by setting the one or more error checking thresholds accordingly. The user input may be provided by a user locally (for example, using a user interface incorporated in the device) or remote (for example, by transmitting to the device an instruction to alter a stochastic rule threshold). Thus, the one or more error checking thresholds may be managed locally or remotely.

Applying one or more stochastic rules to determine the image classification status can allow the device to check the classifications made by the trained machine learning agent. Furthermore, the use of the one or more stochastic rules can allow this determination to be performed quickly and with relatively little computing power. Thus, the use of the one or more stochastic rules can enable a computer vision device to perform self-checking and ongoing training even when deployed in locations at which only limited computing power and communications bandwidth are available.

It may be that the method comprises, in response to the image classification status indicating that the trained machine learning agent has incorrectly classified at least one object in the image, verifying, on the basis of one or more further classifications of objects present in the image, the determined classification status. The one or more further classifications may correspond to at least one of the classifications made in the operating of the trained machine learning agent. The verifying may comprise comparing the one or more classifications with the one or more further classifications (for example, to identify discrepancies).

Verifying the image classification status when it indicates that the trained machine learning agent has incorrectly classified at least one object in the image can ensure that only appropriate data is utilised for further training of the machine learning agent. This can improve the reliability with which the computer vision method adapts the training of the machine learning agent to suit its specific environment.

It may be that the verifying comprises altering the classification threshold. In such cases, it may be that the verifying comprises repeating the operating of the trained machine learning agent using the altered classification threshold to generate the one or more further classifications. Thus, the one or more further classifications may be generated by the trained machine learning agent. The verifying may comprise increasing the classification threshold (thereby requiring a greater classification confidence score to make a classification). This can reduce the likelihood of the one or more further classifications identifying objects which are not present in the image. The verifying may comprise decreasing the classification threshold (thereby requiring a reduced classification confidence score to make a classification). This can reduce the likelihood of the one or more further classifications failing to identify objects present in the image.

It may be that the verifying is performed on the basis of at least one additional image of the scene. In such cases, it may be that the image (i.e. the initial image) was captured at a first point in time from a first viewing position. The at least one additional image of the scene may comprise an image of the scene captured at a second different point in time. The at least one additional image of the scene may comprise an image of the scene captured from a second different viewing position. It may be that the verifying is performed on the basis of multiple images of the scene. Those multiple images may be captured at multiple different points in time. The multiple images may be captured from multiple different viewing positions. It will be appreciated by the skilled person that the multiple images may include a combination of images captured at different times and from different viewing positions. For example, the multiple images may include two or more of: a first image captured at a first time from a first viewing position; a second image captured at the first time from a second viewing position; a third image captured at a second time from the first viewing position; and a fourth image captured at the second time from the second viewing position.

Utilising an additional image of the scene to perform the verifying can provide additional information to inform the classification of objects in the scene. Thus, where the one or more further classifications are generated from an additional image, it may be that the one or more further classifications are based on different information to the original one or more classifications. For example, elements of the scene which are in proximity in the image (for example, an object and its immediately adjacent background) may not be so in the additional image (for example, where a different viewing position of the additional image results in the object having a different background). Thus, where the original classification of an object has been performed incorrectly due to interaction between the object and its immediately adjacent background, a further classification of that object based on an additional image may not be subject to that interaction and therefore may be less likely be incorrect.

It may be that the verifying comprises operating the trained machine learning agent on the basis of the at least one additional image to generate the one or more further classifications. In such cases, it may be that the verifying is performed on the basis of the one or more further classifications.

It may be that the method comprises identifying at least one object in the plurality that has been incorrectly classified. The method may comprise identifying multiple objects that have been incorrectly classified. It may be that the identifying is performed on the basis of the one or more further classifications. It will be appreciated by the skilled person that, where the method does not include a step of verifying the image classification status the steps of obtaining the one or more further classifications (for example, as described above in respect of the verifying of the image classification status) may be performed as part of the identification of incorrect classifications. Thus, it may be that the identification of an incorrectly classified object comprises obtaining one or more further classifications of objects present in the image.

In such cases, it may be that the method comprises correcting the classification of the identified at least one incorrectly classified object. It may be that the correcting is performed on the basis of the one or more further classifications. It may be that the further training is performed on the basis of the corrected classification. Correcting the classification may comprise one or more of: identifying an object which was previously not identified, removing an identified object which was identified in error, and changing the object class to which an object has been allocated.

By identifying objects that have been incorrectly classified and then correcting their classifications, the computer vision method can provide improved (for example, more reliable) classification of objects.

It may be that the method comprises applying a plurality of stochastic rules to the one or more input vectors to determine a respective plurality of image classification statuses. In such cases, it may be that the further training is performed on the basis of the plurality of image classification statuses. It may be that at least one stochastic rule in the plurality differs from the other stochastic rules in the plurality. It may be that each of the stochastic rules differs from the other stochastic rules in the plurality. It may be that all of the plurality of image classifications statuses are associated with the image. It may be that the method comprises combining the plurality of image classification statuses to generate a combined image classification status. It may be that the further training is performed on the basis of the combined image classification status. It may be that the combining comprises performing majority voting amongst the plurality of stochastic rules. Thus, the combining may comprise determining whether more of the plurality of image classification statuses are true than false. It may be that the combined image classification status comprises the most common image classification status amongst the plurality of image classification statuses. Thus, it may be that the determining of the image classification status is based on all of (for example, a combination of) the plurality of stochastic rules.

Alternatively, it may be that the determining of the image classification status is based on a subset of the plurality of stochastic rules. Thus, it may be that the method comprises selecting the one or more stochastic rules from a plurality of stochastic rules. The selecting may be performed on the basis of at least one environmental condition. It may be that the method comprises determining at least one environmental condition at a time and place at which the image was captured. It may be that the selecting is performed on the basis of the determined at least one environmental condition. It may be that the at least one environmental condition comprises one or more of: a weather condition, a time of day, and a location at which the image was captured. It may be that one or more of the plurality of stochastic rules are particularly suited to particular environmental conditions. Utilising a plurality of stochastic rules to determine a respective plurality of image classification statuses can ensure that most suitable stochastic rule(s) for the environmental conditions in which the image was captured is used.

It may be that the image classification status is derived from a plurality (for example, all) of the classifications made by the trained machine learning agent in respect of the image. It may be that at least one principal component in the plurality is associated with a part of the image not containing an object. It may be that the method comprises classifying two or more objects present in the image. In such cases, it may be that the image classification status is indicative of whether all of the two or more objects have been correctly classified. Thus, the image classification status may be determined based on the content of the image as a whole, rather than of any particular subsection of the image.

Determining the image classification status based on the content of the image as a whole enables the computer vision method to recognise incorrect classifications derived from a failure of the machine learning agent to identify an object present in the image. If, for example, classification statuses were generated based on a cropped portions of the image that had been identified as including an object, it would not be possible to determine whether a set of classifications associated with an image was incomplete. Thus, the determining the image classification status based on the content of the image as a whole enables the detection of false negative results.

It may be that the method comprises obtaining further image data associated with a further image. The further image may be of the scene (for example, at a different point in time). In such cases, it may be that the method comprises operating, on the basis of the further image data, the further trained machine learning agent to classify objects present in the further image. Thus, the method may comprise utilising the further trained machine learning agent for classification of objects in subsequent images.

The further training of the machine learning agent improves the ability of the machine learning agent to classify objects in the specific environment in which it has been deployed (for example, including objects present in the scene at other points in time). Thus, using the further trained machine learning agent for classification of objects in subsequent images can provide improved object classification because the further trained machine learning agent is more adapted to its deployment environment.

It may be that the image comprises a frame of video footage. In such cases it may be that the further image comprises a frame of the video footage (for example, different to that of the image). It may be that the at least one additional image comprises a frame of the video footage (for example, different to that of the image and/or the further image). It may be that the method comprises repeating the obtaining, operating, determining in respect of further frames (for example, in respect of each frame) of the video footage. It may be that the method comprises repeating the causing further training of the machine learning agent in respect of the further frames. It may be that the further training is performed only periodically. For example, it may be that the further training is performed at intervals of a predetermined number of frames (for example, every 100 frames). It may be that the further training is performed at predetermined time intervals (for example, every hour). It may be that the further training is performed in response to a false classification rate associated with the device exceeding a predetermined threshold. It may be that the further training is performed in response to receipt of an instruction (for example, from the remote computing device) to perform further training.

It may be that the method comprises recording one or more performance metrics associated with performance of the device. For example, the one or more performance metrics may include one or more of a false classification rate, false positive classification rate, a false negative classification rate, a number of classifications performed (for example, over a predetermined period of time), a number of classifications corrected (for example, over the predetermined period of time), and the plurality of classification thresholds. It may be that the method comprises transmitting the recorded one or more performance metrics to a remote computing resource (for example, for further analysis or monitoring). It may be that the method comprises transmitting, to the remote computing resource, the plurality of classification thresholds. It may be that the method further comprises monitoring the one or more performance metrics to identify a fault condition at the computer vision device. For example, it may be that the remote computing resource is configured to determine, on the basis of the one or more performance metrics, that the computer vision device has entered an error condition. Such an error condition may, for example, include erroneous training of the machine learning agent (for example, such that it enters a catastrophic forgetting state) or physical damage to the computer vision device (for example, to the sensor). Thus, it may be that the method comprises, at the remote computing resource, processing the plurality of classification thresholds to identify an error condition associated with the computer vision device.

It may be that the method comprises, in response to the trained machine learning agent having classified an object, recording (for example, in a census register) data indicative of the classified object. The recorded data may include one or more of: a classification of the object, a classification time, and a location of the object. It may be that the method comprises monitoring classifications made in respect of successive frames of the video footage to track classified objects. The method may comprise maintaining a register of objects present within the scene (i.e. within the field of view of the sensor). Thus, the method may comprise, in response to classifying a new object not present in a preceding frame, adding the new object to the register. The method may comprise, in response to an inability to classify an object present in a preceding frame (for example, because the object is no longer within the scene), removing the object from the register. It may be that the objects are only added to the register following multiple consecutive frames in which the new object is present. It may be that the objects are only removed from the register following multiple consecutive frames in which the new object is present. It may be that the method comprises recording in memory every addition to and removal from the register of an object. Thus, the method may comprise performing a census.

According to a second aspect of the invention, there is provided a computer program comprising a set of instructions, which, when executed by a computer, cause the computer to perform the method of the first aspect.

According to a third aspect of the invention, there is provided a computer vision apparatus comprising:
an image receiving module, configured to receive image data associated with an image of a scene;
a trained machine learning agent configured to classify, on the basis of the image data, objects present in the image, wherein the classifying comprises generating one or more input vectors characterising a plurality of principal components of the image;
a classification checking module configured to determine an image classification status indicative of whether the trained machine learning agent has incorrectly classified at least one object in the image, wherein the determining comprises applying one or more stochastic rules to the one or more input vectors; and
a training module configured to cause further training of the machine learning agent on the basis of the determined image classification status.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a schematic view of a computer vision device according to a first embodiment of the invention; and

FIG. 2 shows a flow chart illustrating the steps of a method according to a second embodiment of the present invention.

### DETAILED DESCRIPTION

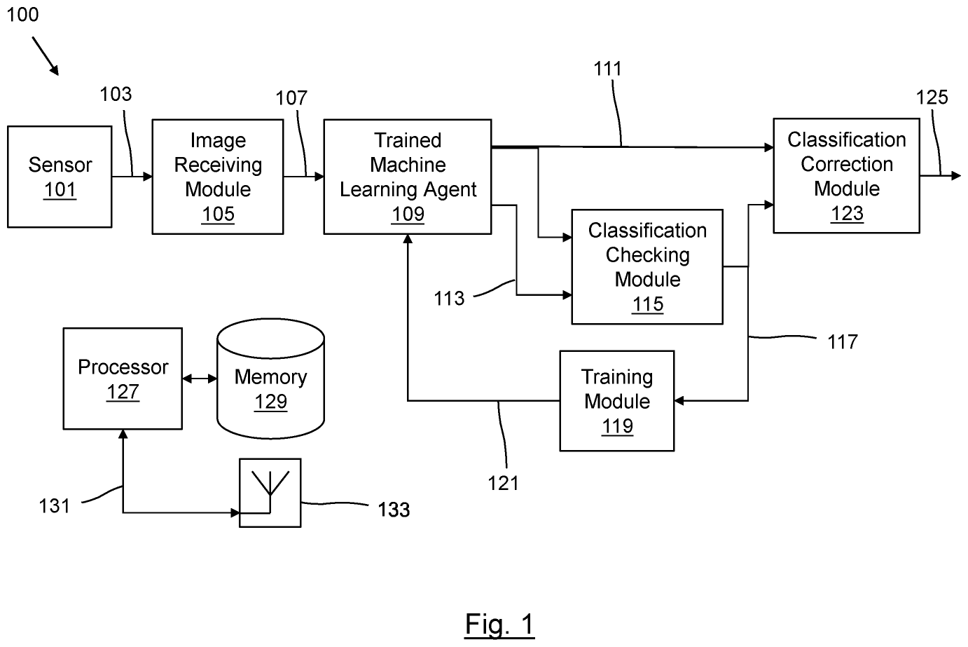

FIG. 1 shows a schematic view of a computer vision device 100 according to a first embodiment of the invention.

The computer vision device 100 comprises a sensor 101. In this example embodiment, the sensor 101 comprises a visible light camera. However, in other embodiments other types of sensor may be used (for example, an infra-red sensor, radar sensor, LIDAR sensor, or a combination thereof). The sensor 101 is configured to capture an image of a scene and generate associated image data 103. In this example embodiment the sensor 101 forms part of the computer vision device 100, however, in other embodiments, the sensor 101 may be separate from the computer vision device. The image data 103 is passed to an image receiving module 105. In this example embodiment, the sensor comprises a video camera configured to capture video footage of the scene. Thus, the captured image comprises one of a plurality of frames in the video footage.

The image receiving module 105 is configured to receive the image data 103 from the sensor 101. Thus, the image receiving module 105 is configured to provide an interface with the sensor 101. In alternative embodiments, the computer vision device does not comprise a sensor. For example, in alternative embodiments, the image receiving module 105 is configured to receive the from an external source (for example, a sensor which is separate from the computer vision device 100). For example, the image receiving module 105 may be configured to receive the image data 103 via a communication link (for example, via a communication network). Thus, in other embodiments, it may be that the computer vision device 100 comprises interface circuitry in order to allow transmission of the image data 103 from the external source to the computer vision device 100. In such cases, the image receiving module 105 may also configured to implement one or more communication or networking protocols (for example, to enable the computer vision device 100 to communicate with the external source via a local area network or the internet). Optionally, the image receiving module 105 is configured to perform pre-processing of the image data 103 to generate processed image data 107. The processed image data 107 is passed to a trained machine learning agent 109. It will be appreciated that, in embodiments where no pre-processing is performed by the image receiving module 105, it is the image data 103 which is passed to the trained machine learning agent 109.

The trained machine learning agent 109 is configured to receive the processed image data 107 and, on the basis of the processed image data 107, operate (for example, by virtue of its training) to classify objects present in the image. Classifying objects present in the image comprises identifying one or more objects present in the image (i.e. determining that an object is present without determining what the object is) and, for each of the identified one or more objects, assigning the object to one of a plurality of predetermined object classes. In this example embodiment, the computer vision device 100 is configured to operate to perform an automated census. Thus, in this case, the predetermined object classes include: cars, trucks, buses, pedestrians, horses, and trains. However, it will be appreciated by the skilled person that the object classes used in a given application will depend on the types of objects that need to be identified and distinguished for that particular application. Thus, other embodiments may utilise more, fewer, and/or different object classes. The trained machine learning agent 109 is configured to determine, for each of the identified one or more objects and each of the one object classes, a classification confidence score indicative of the likelihood that the object belongs to a given object class. Thus, the trained machine learning agent 109 is, in this example embodiment, configured to determine a number of classification confidence scores equal to the product of the number of identified objects and the number of object classes. The trained machine learning agent 109 is also configured to, in response to a classification confidence score for an object in respect of an object class exceeding a classification threshold, assign the object to the object class.

Techniques by which a machine learning agent can be trained to classify objects are well known in the art and will not be discussed in further detail here.

The trained machine learning agent 109 is configured to output one or more classifications 111 associated with objects that the machine learning agent 109 has identified within the image. It will be appreciated by the skilled person that the trained machine learning agent is unlikely to correctly classify all objects present in the image at all times. For example, errors can occur due to the general variation in appearance of objects (i.e. due to the fact that not all objects of a given type have identical appearances), due to variation in the environmental conditions in which the image was captured (for example, changes in lighting or weather conditions), or due to interactions between an object and the background of the image or other objects in the image. Such errors manifest themselves as incorrect classifications. Incorrect classifications may arise in the form of a failure to identify an object present in the image, an erroneously identification of an object in the image that is not actually present, or the assignment of an identified object to an incorrect object class. Thus, the one or more classifications 111 may include at least one incorrect classification.

In the process of classifying objects in the image, the trained machine learning agent 109 is configured to generate a plurality of input vectors 113 characterising a plurality of principal components of the image. The plurality of principal components (and thereby the plurality of input vectors 113) characterise a feature space associated with the image. Specifically, the plurality of principal components are associated with the whole of the image, not merely a subsection of the image (for example, a subsection identified as containing an image). Thus, at least one principal component in the plurality is associated with a part of the image not containing an object.

The one or more classifications 111 and the input vectors 113 are passed to a classification checking module 115. The classification checking module 115 is configured to determine an image classification status indicative of whether any of the one or more classifications 111 are incorrect. The image classification status can have one of two states: true, in which case the one or more classifications 111 are all considered to be correct; or false, in which case at least one of the one or more classifications 111 is considered to be incorrect. Thus, in this example embodiment, the image classification status is derived from all of the classifications made by the trained machine learning agent 109 in respect of the image. Specifically, the image classification status is indicative of whether all objects present in the image have been correctly classified.

The determining is performed by applying one or more stochastic rules to the one or more input vectors 113. The one or more stochastic rules operate by separating the feature space into two or more portions, including a first portion associated with classifications which are likely to be correct, and a second portion associated with classifications which are likely to be incorrect. In this example embodiment, the classification checking module 115 is configured to apply a plurality of stochastic rules to the one or more input vectors 113. Thus, the classification checking module 115 determines a corresponding plurality of image classification statuses (in this example embodiment, one image classification status for each of the plurality of stochastic rules). It will be appreciated by the skilled person that the machine learning agent is configured to learn (through its training) the features of objects in its training dataset. These features are represented in the latent feature space as vectors (i.e. as highly reduced/compressed representations of the features in latent space). The deployed machine learning agent operates to produce latent representations of the live scene on the basis of its training. The machine learning agent is configured to use the latent representations of the live scene to classify input vectors. It will be appreciated by the skilled person that this is based on the assumption that the data distribution of the deployment environment is equivalent to that of the training environment, and that this is not always true in practice. As a result, even the best trained models can be susceptible to spurious errors. The one or more stochastic rules also operate on the latent space. However, rather than looking for similarity, they are configured to calculate the cosine of the inner products of the input data and the training data to classify the data. If the stochastic rules are configured to determine whether the features are correctly classified on the bases of whether calculated cosines are within a predetermined acceptable range.

The classification checking module 115 is further configured to combine the plurality of image classification statuses to generate a combined image classification status. In this example embodiment, the classification checking module 115 is configured to combine the plurality of image classification statuses by performing majority voting amongst the plurality of stochastic rules. Thus, the classification checking module 115 is configured to determine whether more of the plurality of image classification statuses are true than false. If so, then the combined image classification status is set to be true. If not, then the combined image classification status is set to be false. In alternative embodiments, the plurality of image classification statuses may be combined in other ways. For example, the classification checking module 115 may be configured to select a stochastic rule from the plurality. Such a selection may be made on the basis of at least one environmental condition at a time and place at which the image was captured. Thus, the classification checking module 115 may be configured to determining such an environmental condition and select one or more stochastic rules (for example, one or more stochastic rules which are particularly suited to the determined environmental condition) from the plurality on the basis of the determined environmental condition. Such environmental conditions may include one or more of: a weather condition, a time of day, and a location at which the image was captured.

In this example embodiment, the classification checking module 115 is further configured to, in response to the combined image classification status indicating that the trained machine learning agent 109 has incorrectly classified at least one object in the image, verify the combined image classification status. However, in alternative embodiments, the verification step may be omitted. Thus, the classification checking module 115 is configured to output a verified image classification status 117.

The classification checking module 115 is configured to verify the combined image classification status on the basis of one or more further classifications of objects present in the image. The classification checking module 115 is configured to verify the combined image classification status by comparing the classifications with the one or more further classifications. In this example embodiment, the one or more further classifications are generated by processing at least one additional image of the scene using the trained machine learning agent 109. In this example embodiment, the at least one additional image comprises one of more other frames in the video footage. The at least one additional image may be a preceding (for example, immediately preceding) or following (for example, immediately following) frame of the video footage. Thus, the at least one additional image was captured at a different time to the original image. In alternative embodiments, the at least one additional image may be captured from a different viewing position (for example, by a different sensor) to that of the original image. It will be appreciated by the skilled person that the at least one additional image may include images captured both at different times and from different viewing positions to those of the original image. In alternative embodiments, other means of generating the one or more further classifications may be used. For example, the verifying may be performed by altering the classification threshold and reprocessing the image using the trained machine learning agent 109 with the altered classification threshold.

The verified image classification status 117 is passed to a training module 119. The training module is configured to perform further training of the machine learning agent 109 on the basis of the verified image classification status 117. Performing the further training may comprise performing few shot learning. Alternatively or additionally, performing the further training may comprise performing transfer learning. Thus, the training module 119 is configured to generate further training data 121 for use in training the machine learning agent 109. In alternative embodiments, where no verification of the image classification status is performed, the further training may be performed on the basis of the combined image classification status, the plurality of image classification statuses, or (if only one image classification status is generated in respect of the image) the image classification status. The further training of the machine learning agent 109 on the basis of the verified image classification status 117 improves its ability to classify objects in the specific circumstances that have caused it to fail. Furthermore, where those circumstances are a product of the particular environment to which the computer vision device 100 has been deployed, the further training will allow the machine learning agent 109 to adapt to that particular environment.

Subsequent operation of the computer vision device 100 (and, in particular, the machine learning agent 109) is performed on the basis of the further training. Thus, the computer vision device is configured to obtain further image data associated with a further image and operate, on the basis of the further image data, the further trained machine learning agent 109 to classify objects present in the further image.

Optionally, the computer vision device 100 comprises a classification correction module 123. The classification correction module 123 is configured to receive the one or more classifications 111 and the verified image classification status 117. The classification correction module 123 is configured to, in response to the combined image classification status indicating that the trained machine learning agent 109 has incorrectly classified at least one object in the image, identify the at least one object. It will be appreciated by the skilled person that, because the verified image classification status 117 provides only a true/false indication of whether the machine learning agent 109 has correctly classified all relevant objects present in the image, a false result does not provide any indication of which object(s) in the image has been incorrectly classified. The classification correction module 123 is configured to identify the specific objects in the image which have been incorrectly classified (i.e. which classifications have given rise to a false image classification status).

The classification correction module 123 is further configured to correct the classification of the identified at least one incorrectly classified object. In this example embodiment, the classification correction module 123 is configured to perform the correction on the basis of the one or more further classifications. Thus, classification correction module 123 is configured to generate one or more corrected classifications 125. In alternative embodiments, the further training may be performed on the basis of the one or more corrected classifications 125.

The computer vision device 100 further comprises a processor 127 and associated memory 129. Some or all of the functions of the image receiving module 105, the trained machine learning agent 109, the classification checking module 115, the training module 119, or the classification correction module 123 may be implemented, wholly or in part, by the processor 127 (for example, by executing instructions stored within the memory 129).

The computer vision device 100 is further configured (for example, by virtue of the configuration of the processor 127) to record (for example, in the memory 129) one or more performance metrics associated with performance of the device 100. In this example embodiment, the computer vision device 100 is configured to record a false classification rate, a false positive classification rate, a false negative classification rate, a number of classifications performed over a predetermined period of time, a number of classifications corrected over the predetermined period of time, and the plurality of classification thresholds.

The computer vision device is further configured (for example, by virtue of the configuration of the processor 127) to transmit the recorded one or more performance metrics to a remote computing resource (not shown). Thus, the processor 127 is configured to generate communication data 131 associated with the one or more performance metrics for transmission to the remote computing resource. The computer vision device 100 further comprises an antenna 133. In this example embodiment, the computer vision device 100 is configured to transmit the communication data 131 to the remote computing resource by means of a wireless communication link. However, in other embodiments, the communication data 131 may be transmitted over a wired communication link.

The remote computing resource is configured to receive the communication data 131 and, on the basis of the one or more performance metric, perform further analysis and monitoring of the computer vision device 100. The remote computing resource is configured to monitor the one or more performance metrics to identify an error condition at the computer vision device 100. Such an error condition may, for example, include erroneous training of the machine learning agent 109 (for example, such that it enters a catastrophic forgetting state) or physical damage to the computer vision device 100 (for example, to the sensor 101). The remote computing resource is also configured to monitor the plurality of classification thresholds for thresholds indicative of an error condition. For example, extreme values of the plurality of classification thresholds may indicate that the sensor 101 has been damaged or partially obscured. Thus, the remote computing resource is also configured to identify an error condition associated with the computer vision device 100 on the basis of the plurality of classification thresholds.

In this example embodiment, the computer vision device 100 comprises an automated census device. Thus, the computer vision device 100 is configured to, in response to the trained machine learning agent 109 having classified an object, record (for example, in the memory 129) data indicative of the classified object. In this example embodiment, the recorded data includes a classification of the object, a classification time, and a location in the image of the object. However, it will be appreciated by the skilled person that different data may be recorded in other embodiments. The computer vision device 100 is further configured to monitor classifications made in respect of successive frames of the video footage to track classified objects. The computer vision device 100 also maintains a register of objects present within the scene (i.e. within the field of view of the sensor 101). Thus, the computer vision device 100 is configured to, in response to classifying a new object not present in a preceding frame, add the new object to the register. Similarly, the computer vision device 100 is configured to, in response to an inability to classify an object present in a preceding frame (for example, because the object is no longer within the scene), remove the object from the register. The computer vision device 100 is configured to recording (for example, in the memory 129) every addition to and removal from the register.

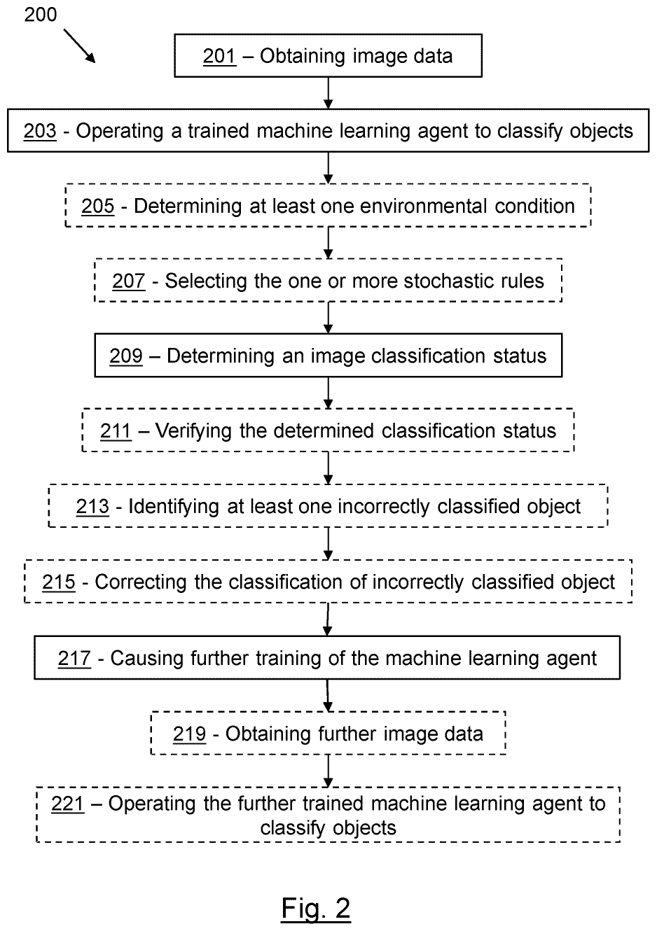

FIG. 2 shows a flow chart illustrating the steps of a method 200 according to a second embodiment of the present invention.

A first step of the method 200, represented by item 201, comprises obtaining image data associated with an image of a scene.

A second step of the method 200, represented by item 203, comprises operating, on the basis of the image data, a trained machine learning agent to classify objects present in the image. The operating comprises generating one or more input vectors characterising a plurality of principal components of the image. Optionally, the classifying comprises identifying one or more objects present in the image. The classifying may also comprise, for each of the identified one or more objects, assigning the object to one of a plurality of predetermined object classes. It may be that incorrectly classifying an object comprises one or more of: failing to identify an object present in the image; erroneously identifying an object in the image that is not present; and assigning an identified object to an incorrect object class. The classifying may comprise (for example, for each of the identified one or more objects) determining a classification confidence score indicative of the likelihood that the object belongs to a given object class. The classifying may also comprise, in response to the classification confidence score exceeding a classification threshold, assigning the object to the object class. The method 200 may comprise classifying two or more objects present in the image. It may be that at least one principal component in the plurality is associated with a part of the image not containing the one or more objects.

An optional third step of the method 200, represented by item 205, comprises determining at least one environmental condition at a time and place at which the image was captured. The at least one environmental condition may comprise one or more of: a weather condition, a time of day, and a location at which the image was captured.

An optional fourth step of the method 200, represented by item 207, comprises selecting the one or more stochastic rules from a plurality of stochastic rules. It may be that the selecting is performed on the basis of the determined at least one environmental condition.

A fifth step of the method 200, represented by item 209, comprises determining an image classification status indicative of whether the trained machine learning agent has incorrectly classified at least one object in the image. Determining the image classification status comprises applying one or more stochastic rules to the one or more input vectors. Optionally, the method 200 comprises applying a plurality of stochastic rules to the one or more input vectors to determine a respective plurality of image classification statuses. The method 200 may comprise combining the plurality of image classification statuses to generate a combined image classification status. The image classification status may be derived from a plurality of the classifications made by the trained machine learning agent in respect of the image. Where the method comprises classifying two or more objects present in the image, the image classification status may be indicative of whether all of the two or more objects have been correctly classified.

An optional sixth step of the method 200, represented by item 211, comprises, in response to the image classification status indicating that the trained machine learning agent has incorrectly classified at least one object in the image, verifying, on the basis of one or more further classifications of objects present in the image, the determined classification status. The verifying may comprise altering the classification threshold and repeating the operating of the trained machine learning agent using the altered classification threshold to generate the one or more further classifications. The verifying may be performed on the basis of at least one additional image of the scene. It may be that the image was captured at a first point in time from a first viewing position and the at least one additional image of the scene comprises an image of the scene captured at a second different point in time and/or an image of the scene captured from a second different viewing position. The verifying may comprise operating the trained machine learning agent on the basis of the at least one additional image to generate the one or more further classifications. In such cases, the verifying may be performed on the basis of the further classifications.

An optional seventh step of the method 200, represented by item 213, comprises identifying at least one object in the plurality that has been incorrectly classified.

An optional eighth step of the method 200, represented by item 215, comprises correcting the classification of the identified at least one incorrectly classified object. The correcting may be performed on the basis of the one or more further classifications.

A ninth step of the method, represented by item 217, comprises causing further training of the machine learning agent on the basis of the determined image classification status. The further training may be performed on the basis of the corrected classification. Where the method comprises applying a plurality of stochastic rules to the one or more input vectors to determine a respective plurality of image classification statuses, it may be that the further training is performed on the basis of the plurality of image classification statuses (for example, on the basis of the combined image classification status).

An optional tenth step of the method 200, represented by item 219, comprises obtaining further image data associated with a further image.

An optional eleventh step of the method 200, represented by item 221, comprises operating, on the basis of the further image data, the further trained machine learning agent to classify objects present in the further image.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

Whilst the embodiments described above relate to an automated census device, it will be appreciated by the skilled person that the computer vision method of the present invention is applicable to many other applications.

Whilst, in the embodiments described above, the one or more stochastic rules are used to enable further training of the machine learning, it will be appreciated that, in other embodiments, it may be that no further training takes place. Similarly, in some embodiments, the classification of objects in the image may be performed by a classifier more generally, rather than specifically a machine learning agent. That is to say that, in such embodiments, it may be that the classifier does not comprise a machine learning agent. Thus, embodiments of the present invention provide a computer vision method comprising:
obtaining image data associated with an image of a scene;
operating, on the basis of the image data, a classifier to classify objects present in the image, wherein the operating comprises generating one or more input vectors characterising a plurality of principal components of the image; and
determining an image classification status indicative of whether the trained machine learning agent has incorrectly classified at least one object in the image, wherein the determining comprises applying one or more stochastic rules to the one or more input vectors.

In such embodiments, it may be that the method comprises identifying the at least one incorrectly classified image (for example, as described above in respect of the first embodiment of the invention). It may be that the method comprises correcting the identified at least one incorrectly classified image (for example, as described above in respect of the first embodiment of the invention). It may be that the method comprises recording data associated with the image classification state (for example, for transmission to and analysis by the remote computing resource).

The computer vision device 100 may comprise one or more processors and/or memory. Each device, module, component, machine or function as described in relation to any of the examples described herein, for example the image receiving module 105, the trained machine learning agent 109, the classification checking module 115, the training module 119, or the classification correction module 123 may similarly comprise a processor or may be comprised in apparatus comprising a processor. One or more aspects of the embodiments described herein comprise processes performed by apparatus. In some examples, the apparatus comprises one or more processors configured to carry out these processes. In this regard, embodiments may be implemented at least in part by computer software stored in (non-transitory) memory and executable by the processor, or by hardware, or by a combination of tangibly stored software and hardware (and tangibly stored firmware). Embodiments also extend to computer programs, particularly computer programs on or in a carrier, adapted for putting the above described embodiments into practice. The program may be in the form of non-transitory source code, object code, or in any other non-transitory form suitable for use in the implementation of processes according to embodiments. The carrier may be any entity or device capable of carrying the program, such as a RAM, a ROM, or an optical memory device, etc.

The one or more processors of the computer vision device 100 may comprise a central processing unit (CPU). The one or more processors may comprise a graphics processing unit (GPU). The one or more processors may comprise one or more of a field programmable gate array (FPGA), a programmable logic device (PLD), or a complex programmable logic device (CPLD). The one or more processors may comprise an application specific integrated circuit (ASIC). It will be appreciated by the skilled person that many other types of device, in addition to the examples provided, may be used to provide the one or more processors. The one or more processors may comprise multiple co-located processors or multiple disparately located processors. Operations performed by the one or more processors may be carried out by one or more of hardware, firmware, and software.

The one or more processors may comprise data storage. The data storage may comprise one or both of volatile and non-volatile memory. The data storage may comprise one or more of random access memory (RAM), read-only memory (ROM), a magnetic or optical disk and disk drive, or a solid-state drive (SSD). It will be appreciated by the skilled person that many other types of memory, in addition to the examples provided, may also be used. It will be appreciated by a person skilled in the art that the one or more processors may each comprise more, fewer and/or different components from those described.

The techniques described herein may be implemented in software or hardware, or may be implemented using a combination of software and hardware. They may include configuring an apparatus to carry out and/or support any or all of techniques described herein. Although at least some aspects of the examples described herein with reference to the drawings comprise computer processes performed in processing systems or processors, examples described herein also extend to computer programs, for example computer programs on or in a carrier, adapted for putting the examples into practice. The carrier may be any entity or device capable of carrying the program. The carrier may comprise a computer readable storage media. Examples of tangible computer-readable storage media include, but are not limited to, an optical medium (e.g., CD-ROM, DVD-ROM or Blu-ray), flash memory card, floppy or hard disk or any other medium capable of storing computer-readable instructions such as firmware or microcode in at least one ROM or RAM or Programmable ROM (PROM) chips.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A computer vision method comprising:
obtaining image data associated with an image of a scene;
operating, on the basis of the image data, a trained machine learning agent to classify objects present in the image, wherein the operating comprises generating one or more input vectors characterising a plurality of principal components of the image;
determining an image classification status indicative of whether the trained machine learning agent has incorrectly classified at least one object in the image, wherein the determining comprises applying one or more stochastic rules to the one or more input vectors; and
causing further training of the machine learning agent on the basis of the determined image classification status.

2. A method according to claim 1, wherein the classifying comprises:
identifying one or more objects present in the image, and
for each of the identified one or more objects, assigning the object to one of a plurality of predetermined object classes.

3. A method according to claim 2, wherein incorrectly classifying an object comprises one or more of:
failing to identify an object present in the image;
erroneously identifying an object in the image that is not present; and
assigning an identified object to an incorrect object class.

4. A method according to claim 2 or 3, wherein the classifying comprises, for each of the identified one or more objects:
determining a classification confidence score indicative of the likelihood that the object belongs to a given object class; and
in response to the classification confidence score exceeding a classification threshold, assigning the object to the object class.

5. A method according to any preceding claim, wherein the method comprises, in response to the image classification status indicating that the trained machine learning agent has incorrectly classified at least one object in the image, verifying, on the basis of one or more further classifications of objects present in the image, the determined classification status.

6. A method according to claims 4 and 5, wherein the verifying comprises:
altering the classification threshold; and
repeating the operating of the trained machine learning agent using the altered classification threshold to generate the one or more further classifications.

7. A method according to claim 5 or 6, wherein the verifying is performed on the basis of at least one additional image of the scene.

8. A method according to claim 7, wherein
the image was captured at a first point in time from a first viewing position; and
the at least one additional image of the scene comprises one or more of:
an image of the scene captured at a second different point in time; and
an image of the scene captured from a second different viewing position.

9. A method according to claim 7 or 8, wherein:
the verifying comprises operating the trained machine learning agent on the basis of the at least one additional image to generate the one or more further classifications; and
the verifying is performed on the basis of the one or more further classifications.

10. A method according to any preceding claim, wherein the method comprises identifying at least one object in the plurality that has been incorrectly classified.

11. A method according to claim 10, wherein the method comprises correcting the classification of the identified at least one incorrectly classified object.

12. A method according to claim 11 and any of claims 5 to 9, wherein the correcting is performed on the basis of the one or more further classifications.

13. A method according to claim 11 or 12, wherein the further training is performed on the basis of the corrected classification.

14. A method according to any preceding claim, wherein:
applying one or more stochastic rules comprises calculating a cosine of inner products of input data to the trained machine learning agent; and
determining the image classification status comprises comparing the calculated cosine to a predetermined acceptable range.

15. A method according to any preceding claim, wherein:
the method comprises applying a plurality of stochastic rules to the one or more input vectors to determine a respective plurality of image classification statuses; and
the further training is performed on the basis of the plurality of image classification statuses.

16. A method according to claim 15, wherein:
the method comprises combining the plurality of image classification statuses to generate a combined image classification status; and
the further training is performed on the basis of the combined image classification status.

17. A method according to any preceding claim, wherein the method comprises:
determining at least one environmental condition at a time and place at which the image was captured; and
selecting the one or more stochastic rules from a plurality of stochastic rules, wherein the selecting is performed on the basis of the determined at least one environmental condition.

18. A method according to claim 17, wherein the at least one environmental condition comprises one or more of: a weather condition, a time of day, and a location at which the image was captured.

19. A method according to any preceding claim, wherein the image classification status is derived from a plurality of the classifications made by the trained machine learning agent in respect of the image.

20. A method according to any preceding claim, wherein at least one principal component in the plurality is associated with a part of the image not containing an object.

21. A method according to any preceding claim, wherein the method comprises classifying two or more objects present in the image.

22. A method according to claim 21, wherein the image classification status is indicative of whether all of the two or more objects have been correctly classified.

23. A method according to any preceding claim, wherein the method comprises:
obtaining further image data associated with a further image; and
operating, on the basis of the further image data, the further trained machine learning agent to classify objects present in the further image.

24. A computer program comprising a set of instructions, which, when executed by a computer, cause the computer to perform a method according to any of claims 1 to 23.

25. A computer vision apparatus comprising:
an image receiving module, configured to receive image data associated with an image of a scene;
a trained machine learning agent configured to classify, on the basis of the image data, objects present in the image, wherein the classifying comprises generating one or more input vectors characterising a plurality of principal components of the image;
a classification checking module configured to determine an image classification status indicative of whether the trained machine learning agent has incorrectly classified at least one object in the image, wherein the determining comprises applying one or more stochastic rules to the one or more input vectors; and
a training module configured to cause further training of the machine learning agent on the basis of the determined image classification status.
